(19) United States
(12) Patent Application Publication
(10) Pub. No.: US 2012/0071695 A1
(43) Pub. Date: Mar. 22, 2012

(54) Synthetic Method of 5,5-Dimethyl-2,4-Adipaldehyde-0,0-Boron Difluoride

(76) Inventors: Lifei Cai, Beijing (CN); Lei Dai, Beijing (CN); Hongyu Zhao, Beijing (CN); Weilong Zhang, Beijing (CN); Libai Shao, Beijing (CN); Xiaofeng Wang, Beijing (CN)

(21) Appl. No.: 13/321,119

(22) PCT Filed: May 5, 2010
(86) PCT No.: PCT/CN2010/072444

§ 371 Date: Nov. 17, 2011

(30) Foreign Application Priority Data
May 20, 2009 (CN) 200910084516.8

(51) Int. Cl. C07F 5/02

(52) U.S. Cl. 568/6

(57) ABSTRACT

This invention, which involves synthetic method of 5, 5- dimethyl-2, 4-adipaldehyde-0, 0-Boron difluoride, belongs to the field of organic synthesis. Synthetic method of 5, 5-dimethyl-2, 4-adipaldehyde-0, 0-Boron difluoride is to react pinacolone and boron trifluoride diethyl ether at low temperature, and then add aqueous alkaline solution in after treatment to extract product from ether, after that, separate fluid, condense organic phase and final product is obtained. Yield of this method is 2 to 3 times higher than that in literature, and apart from that, mild reaction condition, simple procedures, easy operation, and low cost make it easy for industrial production. The product can be used directly in next step reaction without any special purification.

### TECHNICAL FIELD

This invention, which belongs to the field of organic synthesis, involves synthesis of key intermediate of DCJTB, and the synthetic method of 5, 5- dimethyl-2, 4-adipaldehyde-0, 0- Boron difluoride in particular.

### TECHNICAL BACKGROUND

Organic light-emitting diodes (OLEDs) are highly efficient and able to produce colors that cover the entire visible region, therefore, they possess great application prospect in the field of flat panel display technology.

The excellent performance of OLEDs and their great application prospect in the field of flat panel display technology have attracted great attention. In order to realize color display, a series of green, blue and red luminescent materials with high luminous efficiency and good performance need to be developed. After over a decade of in-depth study, green and blue light-emitting materials of high brightness and efficiency have already been obtained, but red emitter is still relatively underdeveloped. In the field of organic electroluminescence, the most widely used intramolecular charge transfer red dyes is DCM dyes. In 2000, Tang et al reported to use 8-tris-hydroxyquinoline aluminum (Alq3) as host materials (C. H. Chen, Tang, C. W., J. Shi, Thin solid Films, 2000, 363, 327-331), DCM1 and DCJ as guests to obtain efficient red luminescence devices, since then, DCM dyes were widely studied and applied. However, DCM and DCJ had the disadvantage of concentration quenching while applied in devices, therefore, Tang et al improved DCJ and gained compound DCJT by replacing C-1 site and C-4 site of Julolidine. Though DCJT possessed good electroluminescent performance, there were many problems in its synthesis procedure, as well as isolation and purification. This is because two active methyl exist in 2,6-dimethy-(4-dinitrile methene)-tetrahydropyran, the precursor used during the synthetic process, so DCJT will further react with acetal and produce condensation byproducts 4-dinitrile methene-2,6-di(ljulolidine-9-vinyl)-tetrahydropyran (bis-DCJT)which not only reduces yield, but also increases the difficulty of product isolation and purification. In light of the problems existed in synthetic process, Chen et al designed DCJTB. Since the synthetic method has been improved, the synthesis and purification of this compound possess good red luminescence properties (Chin H. Chen, C. W. Tang, J. Shi, U.S. Pat. No. 5,935,720).

DCJTB is currently the most successful red emitter whose brightness, efficiency and life all satisfy commercial application. The U.S. Pat. No. 5,935,720 provides the synthetic method of DCJTB, which is docking two intermediates together, one of the intermediates is 2-methyl-6-t-butyl-4-dicyanomethylene-tetrahydropyran, the other is 1,1,7,7-tetramethyl-9-julolidine 1,1,7,7- tetramethyl -9- julolidine-aldehyde. Synthetic method of the second intermediate has already been settled, but yield of the first one is still very low, thus causing high industrial cost of producing DCJTB, and application of OLED is also limited, therefore, intermediate 2-methyl-6-t-butyl-4-dicyanomethylene-tetrahydropyran becomes the bottleneck of DCJTB industrialization.

Since yields of every synthetic procedure of the main intermediate 2-methyl-6-t-butyl-4-dicyanomethylene-tetrahydropyran (see below) are very low, the DCJTB synthesis is quite expensive, which limits its application. In order to spread the application of DCJTB, all the synthetic procedures of intermediate 2-methyl-6-t-butyl-4-dicyanomethylene-tetrahydropyran (formula E), 5, 5-dimethyl-2, 4-adipaldehyde-0, 0-Boron difluoride (formula B), 7- dimethylamino-2,2-dimethyl-6- olefin-3,5-suberic dialdehyde-0, 0-Boron difluoride (formula C), 2-methyl-6-t-butyl-pyrone (formula D) need to be improved.

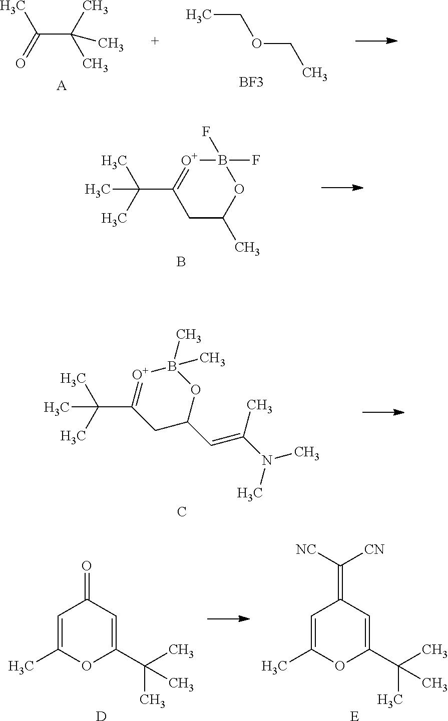

### Content of This Invention

On the basis of the above patent, this invention provides a synthetic method of 5, 5-dimethyl-2, 4-adipaldehyde-0, 0-Boron difluoride whose yield is more than third of the method provided in literature, meanwhile, the product obtained is in high purity that could be used in next step reaction without any purification process.

Synthetic method of 5, 5-dimethyl-2, 4-adipaldehyde-0, 0-Boron difluoride: add boron trifluoride diethyl ether in pinacolone, acetic anhydride solution under the temperature of −30° C.-50° C. and the protection of nitrogen, then react at room temperature, the mole ratio of stated pinacolone and boron trifluoride diethyl ether=1:1-1:10.

The optimum mole ratio of pinacolone and boron trifluoride diethyl ether=1:3-1:6.

The stated boron trifluoride should be dropped into solutions, and the adding temperature of boron trifluoride diethyl ether is −30° C.-30° C.

The stated reaction time under room temperature is 15-24 hours.

The stated synthetic method also includes after treatment which is to add aqueous alkaline solution into reaction liquid at low temperature until it becomes neutral, then separate fluid, condense organic phase and final product is obtained.

The stated aqueous alkaline solution is NaOH solution, sodium bicarbonate solution, sodium carbonate solution, potassium carbonate solution or/and hydroxide potassium solution.

Drop the stated aqueous alkaline solution which is 10% NaOH solution, 10% sodium bicarbonate solution, 10% sodium carbonate solution, 10% potassium carbonate solution or/and 10% hydroxide potassium solution into reaction liquid.

In the stated after treatment procedures, temperature of reaction liquid should not higher than room temperature.

On the basis of large amounts of literature, inventor of this patent summarized reasons of low experimental yield and proposed a method to improve it. Though lots of literature mentioned similar synthetic method of intermediate B, the yield and mole ratio of reaction reagent added were not the same. Since acetylaton oxygen ion are produced during synthetic process of intermediate B, the reaction should take place at low temperature and under protection of nitrogen. After condensation reaction between pinacolone and acetylaton oxygen ion, pinacolone need to react with boron trifluoride, this step determines the whole reaction speed. After drop boron trifluoride diethyl ether at low temperature, react 15-24 hours. This reduces production of oily substances. The amount of boron trifluoride diethyl ether used is very important to the whole reaction, because in which boron trifluoride acts as reactant and catalyst. If boron trifluoride is not enough, generation of boride will be incomplete, and compound B has to be extracted from boron trifluoride diethyl ether, so the stated mole ratio of pinacolone and boron trifluoride diethyl ether=1:1-1:10, and the optimum mole ratio=1:3-1:6.

After all the chemical reactions are completed, the product need to be extracted from reaction fluid, so after treatment will also affect yield and purity of product. During after treatment, since low-temperature treatment has been adopted throughout this invention (drying solvent at 90° C. in literature), and the product is dissolved in ether, so it is preferred to extract the product by separating fluid and then condensing, and high-yield product B will be obtained. This method saves time of after treatment, and meanwhile, low-temperature treatment does not have too much effect on reactants, thus reducing generation of large amount of impurities. The product obtained can be directly used in next step reaction, and yield of this method is 60%-80%, which is over three times of the yield in literature. Low temperature means temperature lower than room temperature that achieved according to routine operation of chemical test, such as ice bath, salt-ice bath, dry ice, liquid nitrogen, etc. The optimum temperature is lower than room temperature but very close to it, which is easy to achieve through ice bath or salt-ice bath.

The synthetic procedures invented are as follows:

Under temperature of −30° C.-50° C., optimum temperature is −30° C.-30° C.; add pinacolone and boron trifluoride diethyl ether in accordance with quantity mole ratio of 1:1-1:10, optimum mole ratio=1:3-1:6; after reaction is completed, add water and alkaline solid, 10% NaOH solution, 10% sodium bicarbonate solution, 10% sodium carbonate solution, 10% potassium carbonate solution or 10% hydroxide potassium solution until the reaction fluid is neutral, it is preferred to maintain its temperature under room temperature, then compound B of 60%-80% yield is obtained.

Compared with synthetic method provided by American patent literature, the method offered by this invention possesses the following features:

(1) Yield of the method provided here is higher and this method is easy to operate.

(2) Mild reaction condition, simple procedures, and low cost make it easy for industrial production.

(3) Compound B, whose yield is higher, could be used directly in next step reaction without any special purification.

### PRACTICAL IMPLEMENTATION MODES

This invention is further explained below in combination of implementation examples.

### Implementation Example 1: 5,5- Dimethyl-2, 4- Adipaldehyde-0, 0- Boron Difluoride

Put 3000 ml flask-4-neck in salt-ice bath; add 100 g pinacolone and 204 g acetic anhydride under the protection of nitrogen; mix and stir them, and then cool them in salt and ice, after that, drop 500 g boron trifluoride diethyl ether complex, react overnight under room temperature. After cooling through salt and ice, drop 10% NaOH solution until pH=7, set it still, separate fluid, and condense organic phase, 120 g yellowish solid is separated out, the yield is 60% (reported yield of U.S. Pat. No. 5,935,720 is 20%). Melting point: 82-84° C.

HNMR (CDCl₃, 400 Hz): 1.19(9H,s); 2.2487(3H,s); 5.97(1H,s)

### Implementation Example 2

Amplify ten times in accordance with ratio, the yield is 62%.

1. A method of synthesizing 5, 5-dimethyl-2, 4-adipaldehyde-0, 0- Boron difluoride comprising: add boron trifluoride diethyl ether in pinacolone, acetic anhydride solution under the temperature of −30° C.-50° C. under the protection of nitrogen, then react at room temperature, the molar ratio of stated pinacolone and boron trifluoride diethyl ether=1:1-1:10.

2. The synthetic method according to claim 1, the mole ratio of stated pinacolone and boron trifluoride diethyl ether=1:3-1:6.

3. The synthetic method according to claim 1, the stated boron trifluoride should be dropped into solutions, and the adding temperature of boron trifluoride diethyl ether is −30° C.-30° C.

4. The synthetic method according to claim 1, the stated reaction time under room temperature is 15-24 hours.

5. The synthetic method according to claim 1, the stated synthetic method also includes after treatment which is to add aqueous alkaline solution into reaction liquid at low temperature until it becomes neutral, then separate fluid, condense organic phase and final product is obtained.

6. The synthetic method according to claim 5, the stated aqueous alkaline solution is NaOH solution, sodium bicarbonate solution, sodium carbonate solution, potassium carbonate solution or/and hydroxide potassium solution.

7. The synthetic method according to claim 6, drop the stated aqueous alkaline solution which is 10% NaOH solution, 10% sodium bicarbonate solution, 10% sodium carbonate solution, 10% potassium carbonate solution or/and 10% hydroxide potassium solution into reaction liquid.

8. The synthetic method according to claim 1, in the stated after treatment procedures, temperature of reaction liquid should not higher than room temperature.
